(19) United States
(12) Patent Application Publication
(10) Pub. No.: US 2024/0086977 A1
(43) Pub. Date: Mar. 14, 2024

(54) AUTOMATIC DIRECTING OF ONLINE PRODUCT RETURNS

(71) Applicant: INTERNATIONAL BUSINESS MACHINES CORPORATION, ARMONK, NY (US)

(72) Inventors: Randy A. Rendahl, Raleigh, NC (US); PRAPTHI CARIAPPA KAYAPANDA, Cary, NC (US); Frank Isaacs, Wake Forest, NC (US); Ashley Kristin Silva, Durham, NC (US)

(21) Appl. No.: 17/931,719

(22) Filed: Sep. 13, 2022

(51) Int. Cl. G06Q 30/02; G06Q 10/08; G06Q 30/06

(52) U.S. Cl. CPC G06Q 30/0279; G06Q 10/0837; G06Q 30/0633

(57) ABSTRACT

An embodiment for automatically directing online product returns to charitable organizations. The embodiment may automatically receive a wish list from one or more charitable organizations. The embodiment may automatically receive distribution information from a vendor. The embodiment may automatically receive a return request for a product from a customer. The embodiment may automatically determine whether the product included in the received return request is eligible for distribution based on the distribution information from the vendor. The embodiment may automatically identify one or more charitable organizations eligible to receive the product. The embodiment may automatically generate a ranking for each of the identified one or more charitable organizations eligible to receive the product. The embodiment may automatically generate a return shipping label corresponding to a highest ranked charitable organization eligible to receive the product.

### BACKGROUND

The present application relates generally to handling the return of merchandise, and more particularly, to a method for automatically directing online product returns to charitable organizations.

Electronic commerce (E-commerce) involves transactions conducted electronically, usually over the Internet. In recent years, e-commerce has expanded its share of the retail marketplace. It is well known that returns in the e-commerce space are more common than in brick-and-mortar store purchases. Many businesses that engage in e-commerce strive to direct a portion of their product returns to charitable organizations.

### SUMMARY

According to one embodiment, a method, computer system, and computer program product for automatically directing online product returns to charitable organizations is provided. The embodiment may include automatically receiving a wish list from one or more charitable organizations. The embodiment may also include automatically receiving distribution information from a vendor. The embodiment may further include automatically receiving a return request for a product from a customer. The embodiment may also include automatically determining whether the product included in the received return request is eligible for distribution based on the distribution information from the vendor. The embodiment may further include, in response to determining that the product included in the received return request is eligible for distribution, automatically identifying one or more charitable organizations that are eligible to receive the product. The embodiment may also include automatically generating a ranking for each of the identified one or more charitable organizations eligible to receive the product. The embodiment may further include, based upon the generated rankings, automatically generating a return shipping label corresponding to a highest ranked charitable organization eligible to receive the product.

### BRIEF DESCRIPTION OF THE SEVERAL VIEWS OF THE DRAWINGS

These and other objects, features and advantages of the present disclosure will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment; and

FIG. 2 illustrates an operational flowchart for a process of automatically directing online product returns to charitable organizations according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. The present disclosure may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present application relate generally to handling the return of merchandise, and more particularly, to a method for automatically directing online product returns to charitable organizations. The following described exemplary embodiments provide a system, method, and program product to, among other things, automatically receive a wish list from one or more charitable organizations, automatically receive distribution information from a vendor, automatically receive a return request for a product from a customer, automatically determine whether the product included in the received return request is eligible for distribution based on the distribution information from the vendor, and then in response to determining that the product included in the received return request is eligible for distribution, automatically identify one or more charitable organizations that are eligible to receive the product. The following described exemplary embodiments provide a system method, and program product that may then automatically generate a ranking for each of the identified one or more charitable organizations eligible to receive the product, and, based upon the generated rankings, automatically generate a return shipping label corresponding to a highest ranked charitable organization eligible to receive the product. Therefore, the presently described embodiments have the capacity to improve automatically directing online product returns to charitable organizations by providing a method to utilize vendor distribution information to which products are eligible for return, and further providing a method to directly connect the returned products with charitable organizations that specifically request the item in advanced, while generating a score to determine an optimal recipient in cases involving multiple charitable organizations.

As previously described, e-commerce involves transactions conducted electronically, usually over the Internet. In recent years, e-commerce has expanded its share of the retail marketplace. It is well known that returns in the e-commerce space are more common than in brick-and-mortar store purchases. Vendors engaging in e-commerce have conventionally used a returns processing approach similar to that of brick-and-mortar retailers, such as by designating in advance one or more of their distribution centers or other specialized return centers (e.g., centers geographically distributed throughout the areas in which customers typically reside) to which customers ship all returned items. In other situations, a vendor may designate in advance one or more third-party return locations to which all items being returned will be shipped, such as a return processing location of a third-party service provider who performs specified types of processing on the items. This processing may include significant human cost. For example, some such third-party service providers may perform activities to verify received items before forwarding the items back to the vendor, or in other situations may dispose of the returned items in manners other than returning them to the vendor (e.g., by storing the items until they are distributed to another destination). In other situations, a pre-designated third-party return location may merely be an off-site location that receives shipped packages having returned items so that the vendor can retrieve their packages from that location, such as by using Parcel Return Services of the regional Bulk Mail Centers (BMCs) of the United States Postal Service (USPS).

These conventional returns processing approaches create various problems for vendors engaging in e-commerce and include several associated costs. For example, when a customer is not geographically near a pre-designated return location, the shipping of the items being returned may be expensive and may take an unduly long time to occur, resulting in a longer time before the customer receives their refund and before the vendor is able to resell the item. Furthermore, delays in return processing can create financial difficulties for merchants if the items being returned depreciate in value rapidly. In addition, for merchants that sell a wide variety of merchandise, some types of items may require specialized return processing (e.g., items of high value and/or of technical complexity, such as jewelry or electronics) that is costly to replicate at multiple locations, and thus items of that type that are being returned may ultimately need to be sent to a single remote location that performs the specialized return processing. Furthermore, there is a significant environmental cost to multiple shipments of return products first to a return location, and then to a third party.

Many vendors have made an effort to donate and ship return products to charitable organizations. However, similarly to the approaches discussed above, this often involves significant human cost and transportation costs. For example, a vendor may first ship the return products to a warehouse or other structure for categorizing and processing of the returned items, and then a charitable organization may buy from a given category based on the charitable organization's needs.

Accordingly, a method, computer system, and computer program product for employing improved methods for automatically directing online product returns to charitable organizations would benefit many vendors who are seeking to donate return products in a cost-efficient manner, as well as charitable organizations seeking to benefit from obtaining return products for little to no cost. The method, system, and computer program product may automatically receive a wish list from one or more charitable organizations. The method, system, computer program product may automatically receive distribution information from a vendor. According to one embodiment, the method, system, computer program product may then automatically receive a return request for a product from a customer. The method, system, computer program product may then automatically determine whether the product included in the received return request is eligible for distribution based on the distribution information from the vendor. Then, the method, system, computer program product may, in response to determining that the product included in the received return request is eligible for distribution, automatically identify one or more charitable organizations that are eligible to receive the product. The method, system, computer program product may then automatically generate a ranking for each of the identified one or more charitable organizations eligible to receive the product. Then, the method, system, computer program product may, based upon the generated rankings, automatically generate a return shipping label corresponding to a highest ranked charitable organization eligible to receive the product. In turn, the method, system, computer program product has provided improved methods for automatically directing online product returns to charitable organizations by providing a direct and efficient return system that utilizes vendor distribution information and generated rankings to improve automatic direction of online product returns to charitable organizations in a cost-efficient manner for vendors that provides for little to no cost incurred by the receiving charitable organization.

The present invention may be a system, a method, and/or a computer program product at any possible technical detail level of integration. The computer program product may include a computer readable storage medium (or media) having computer readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

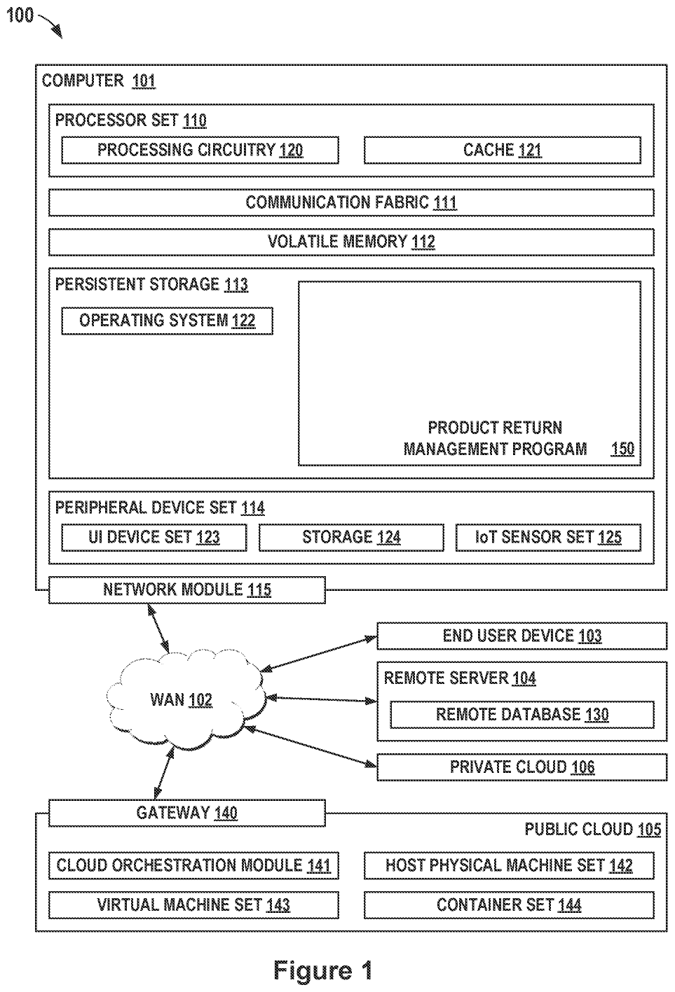

Referring now to FIG. 1, computing environment 100 contains an example of an environment for the execution of at least some of the computer code involved in performing the inventive methods, such as product return management program/code 150. In addition to product return management code 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and product return management code 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in product return management code 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in product return management code 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

According to the present embodiment, the product return management program 150 may be a program capable of automatically receiving a wish list from one or more charitable organizations. Product return management program 150 may then automatically receive distribution information from a vendor. Next, product return management program 150 may automatically receive a return request for a product from a customer. Product return management program 150 may then automatically determine whether the product included in the received return request is eligible for distribution based on the distribution information from the vendor. Next, product return management program 150 may, in response to determining that the product included in the received return request is eligible for distribution, automatically identify one or more charitable organizations that are eligible to receive the product. Product return management program 150 may then automatically generate a ranking for each of the identified one or more charitable organizations eligible to receive the product. Product return management program 150 may then, based upon the generated rankings, automatically generate a return shipping label corresponding to a highest ranked charitable organization eligible to receive the product In turn, product return management program 150 provided improved methods for automatically directing online product returns to charitable organizations by providing a direct and efficient return system that utilizes vendor distribution information and generated rankings to improve automatic direction of online product returns to charitable organizations in a cost-efficient manner for vendors that provides for little to no cost incurred by the receiving charitable organization.

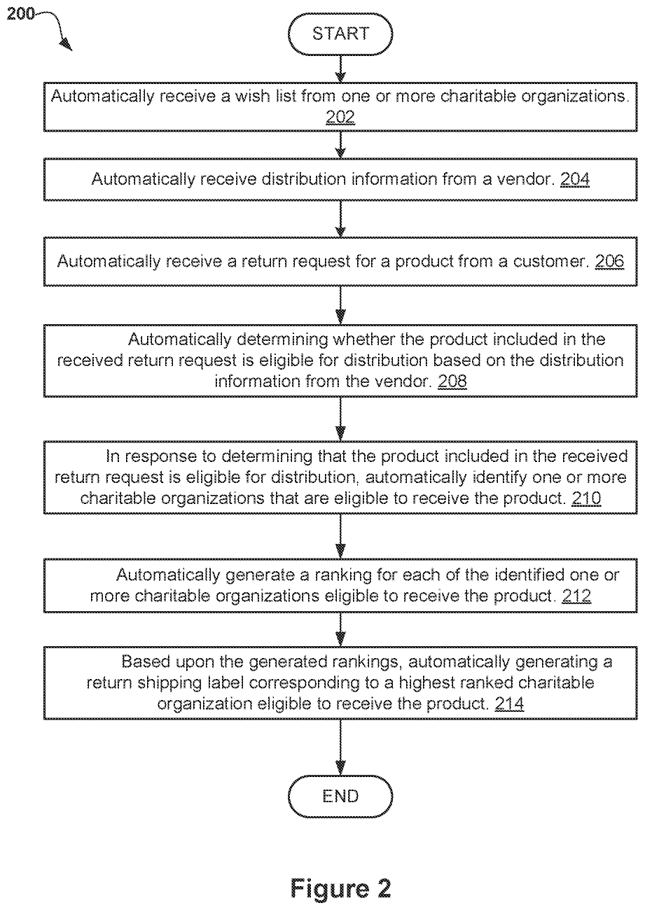

Referring now to FIG. 2, an operational flowchart for a process 200 of automatically directing online product returns to charitable organizations according to at least one embodiment is provided.

At 202, product return management program 150 may automatically receive a wish list from one or more charitable organizations. In the context of this disclosure a ‘wish list’ refers to a written collection of desired products or categories of products created by a given charitable organization. In embodiments, the one or more charitable organizations may utilize an exemplary user interface device set 123 to input various desired products or categories of products that may be received by product return management program 150 and ultimately stored in exemplary storage 124 which may include a database therein. (See FIG. 1) In embodiments, product return management program 150 may utilize known natural language processing components to interpret received wish lists in order to determine the contents contained therein to best sort the wish lists when they are stored in an exemplary database. Generally, a given charitable organization's wish list is created by a user associated with the charitable organization. The wish list may identify specific desired products that are available for purchase on a given e-commerce website having a variety of vendors. For example, product return management program 150 may receive a wish list from an exemplary charitable organization A, and the received wish list may include specific exemplary products ‘Product 1’, ‘Product 2’ and ‘Product 3’ being sold on an exemplary e-commerce Website Z including multiple vendors. Therefore, product return management program 150 detects that Charitable organization A is interested in obtaining the three listed products if a vendor selling these products receives a return request from a given customer. In embodiments, in addition to receiving and storing a given charitable organization's wish list of desired products, product return management program 150 may automatically and simultaneously receive and store financial history information as well as tax information of a given charitable organization or non-profit organization to facilitate any vetting or approval processes. In other embodiments, product return management program 150 may optionally receive and store specific price ranges the charitable organization is willing to pay for desired products, or specific return product conditions a charitable organization would be willing to accept. For example, a user for a given charitable organization may specify whether the charitable organization will accept clothes that are new, worn, lightly used, etc. In other words received charitable organization wish lists may further include information in the form of thresholds, such as price threshold for a particular product, or a product condition threshold. In embodiments, product return management program 150 may automatically receive and store any information from a given charitable organization that helps to more easily determine the needs and desires of a given charitable organization for various return products of interest.

At 204, product return management program 150 automatically receives distribution information from a vendor. In the context of this disclosure, a vendor is any entity, business, website, or individual that is selling one or more products. Distribution information refers to a given set of vendor rules and/or conditions for a specific returnable product to be eligible for distribution to a charitable organization or non-profit organization. In embodiments, product return management program 150 may automatically receive distribution information from any vendors that choose to participate in a product return distribution network that employs and is configured to communicate with exemplary product return management programs in accordance with the presently described embodiments. The vendors may input distribution information by using user interface 124 and product return management program 150 may then store the received vendor distribution information into storage via a database. In embodiments, the database may be the same database that the charitable organizations' wish lists of 202 are stored in. In other embodiments, the vendor distribution information may be stored in a relational database that is related to the databases including the charitable organizations' wish lists. Vendor distribution information may include, for example, specific vendor-sold products that are eligible for distribution upon being returned, vendor rules regarding the condition a returned product must be in to be eligible for distribution, vendor rules regarding specific prices for each returnable product in various conditions, and any other suitable vendor rules or vendor information related to a returnable product that may be eligible for distribution to a charitable organization or other entity. For example, product return management program 150 may automatically receive exemplary distribution information from an exemplary ‘Vendor V’ which indicates that Vendor V sells an exemplary ‘Product P’ that is returnable. The exemplary distribution information from Vendor V may further indicate that Product P may only be distributed to a charitable organization when the product condition is at least ‘New’ or ‘Good’, and may not be distributed when the product has a condition of ‘Poor’ or ‘Fair’.

At 206, product return management program 150 automatically receiving a return request for a product from a customer. The return request may be received via a given vendor's website, a user interface, email, chatbot, phone call recording with transcript (VoIP) that interprets the call, or by any other suitable mechanism. Product return management program 150 may then store the information associated with a given return request into storage by storing it within a separate database or a relational database as discussed in the previously described steps. For example, product return management program 150 may automatically receive a return request for exemplary Product P from a Customer C. Product return management program 150 may be configured to receive a variety of data and information associated with a given return request. For example, in embodiments, product return management program 150 may be configured to receive return requests including information regarding the condition of the product being returned. In such embodiments, product return management program 150 may include image recognition technology to allow it to determine the condition of a product being returned and generate a corresponding condition score. For example, product return management program 150 may use the image recognition technology or software to compare a received image to an image of a new or unused version of the product being considered. In other embodiments, product return management program 150 may receive and store customer's reasons for returning the product, utilizing known natural language processing methods to interpret any customer feedback or information received with a given return request.

At 208, product return management program 150 automatically determines whether the product included in the received return request is eligible for distribution based on the distribution information from the vendor. To accomplish this, product return management program 150 may determine based upon the received and stored vendor distribution information when a returned product is eligible for distribution to a charitable organization. Product return management program 150 may further consider resale values of returned products, condition of returned products, and any vendor rules as received in the distribution information discussed above. For example, product return management program 150 may receive a return request from a customer C for a product P sold to them by a vendor V that is in new condition, but that the customer did not want because they purchased a substitute product from a competitor during the time in which the product was being shipped. At 208, product return management program 150 may utilize Vendor V's stored distribution information for product P to determine if the product included in the received return request is eligible for distribution. In this case, if product return management program 150 determines that Vendor V's stored distribution information indicates that product P is eligible for distribution when in new condition, then product management program 150 will determine that the product P in the received return request is indeed eligible for distribution.

At 210, product return management program 150, in response to determining that the product included in the received return request is eligible for distribution, automatically identifies one or more charitable organizations that are eligible to receive the product. For example, using the example above, once product return management program has identified exemplary product P is eligible for distribution, product return management program 150 will automatically identify one or more charitable organizations eligible to receive the product P. Product return management program 150 accomplishes this by utilizing the information about each charitable organization or non-profit organization gathered at step 202 described above by retrieving the relevant stored information. It is expected that product return management program 150 may identify multiple charitable organizations that are eligible to receive the product. How product return management program 150 determines which of the one or more eligible charitable organizations will ultimately receive the product will be discussed below.

At 212, product return management program 150 automatically generates a ranking for each of the identified one or more charitable organizations eligible to receive the product. In embodiments, product return management program may generate rankings represented as numerical scores. Product return management program 150 may consider a variety of factors in generating the rankings. For example, in embodiments, product return management program may consider shipping expense cost from a given return site, the price a given recipient is willing to pay, whether the returned product is allowed to be donated for free, the need or priority of a given eligible charitable organization to receive the returned product, and any other factors that the e-commerce site (or even vendors) employing product return management program 150 wants considered. The generated ranking will be highest for the eligible charitable organization that, based upon the factors, is most appropriate to receive a given returned product. For example, if product return management program 150 determines that three exemplary charitable organizations including Charitable organization C1, Charitable organization C2 and Charitable organization C3 are eligible to receive an exemplary product P that is being returned, product return management program 150 may then generate rankings for each of charitable organizations C1, C2, and C3 respectively. Charitable organization C1 may be the closest in geographical proximity to the customer and may have a strong need for the product being returned, evidenced by a high priority for the product on the received wish list for charitable organization C1. If product return management program 150 is configured to consider shipping expense cost, and the needs and priorities of a given eligible charitable organization as factors for generating rankings, then product return management program 150 would generate a relatively higher numerical score for charitable organization C1 (as compared to C2 and C3) based on the factors considered, which would result in product return management program 150 generating a higher ranking for charitable organization C1. Product return management program 150 may be configured prior to being deployed to assign a desired weight or priority value to each factor considered by the organization employing product return management program 150. This allows any organization deploying product return management program 150 to weigh or prioritize factors in a way that best suits the organization's individual goals or priorities.

At 214, product return management program 150 based upon the generated rankings, automatically generates a return shipping label corresponding to a highest ranked charitable organization eligible to receive the product. For example, using the example above in connection with step 212, product return management program 150 may generate a return shipping label corresponding to charitable organization C1 as it was the highest ranked charitable organization eligible to receive the product. The generated return shipping label may include, for example, a bar code, and may functionally ensure that the returned product will ship directly to the address of the highest ranked charitable organization.

Accordingly, product return management program 150 provides improved methods for automatically directing online product returns to charitable organizations by providing a direct and efficient return system that utilizes vendor distribution information and generated rankings to improve automatic direction of online product returns to charitable organizations in a cost-efficient manner for vendors that provides for little to no cost incurred by the receiving charitable organization. Product return management program 150 is especially useful for systems having a pool of demand including charitable organizations that generally will not expect to pay full or even minimally discounted amounts and may not have very specific product or feature restrictions, but at the same time may have a longer-term horizon of when they hope to receive a product. Described embodiments provide the opportunity to prioritize and choose where a returned product goes based on several factors discussed above, the factors being sourced from charitable organization wish lists, vendor distribution information, and factors for generating rankings. This may be especially beneficial in situations in which returns are more likely to be shunted into a secondary market or even disposed of, rather than turned around and shipped to alternate customers. Product return networks employing product return management program 150 provide methods for eliminating or reducing the costs associated with maintaining warehouses, warehouse personnel, and transportation costs when trying to distribute returned products to charitable organizations.

In some embodiments, product return management program 150 may include design variations with regard to the above-described examples. In some embodiments, if the returned product is to be sold to a charitable organization, or marked down for other users or organizations, then users and organizations that have this item on a stored wish list will receive a notification (email, etc) letting them know the item is available. In other embodiments, the customer who is returning the item could retain possession of the item until a recipient is chosen. In embodiments, the vendor or e-commerce site could offer a discount on future purchases for instances in which a customer retains possession. In other embodiments, the customer may be issued a refund immediately—which could be re-charged later if the item is never shipped once a recipient is chosen.

It may be appreciated that FIG. 2 provides only an illustration of an exemplary implementation and does not imply any limitations with regard to how different embodiments may be implemented. Many modifications to the depicted environment may be made based on design and implementation requirements.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-based method for automatically directing online product returns to charitable organizations, the method comprising:
automatically receiving a wish list from one or more charitable organizations;
automatically receiving distribution information from a vendor;
automatically receiving a return request for a product from a customer;
automatically determining whether the product included in the received return request is eligible for distribution based on the received distribution information from the vendor;
in response to determining that the product included in the received return request is eligible for distribution, automatically identifying one or more charitable organizations that are eligible to receive the product;
automatically generating a ranking for each of the identified one or more charitable organizations eligible to receive the product; and
based upon the generated rankings, automatically generating a return shipping label corresponding to a highest ranked charitable organization eligible to receive the product.

2. The computer-based method of claim 1, wherein automatically receiving the wish list from the one or more charitable organizations further comprises:
automatically receiving and storing specific price ranges the one or more charitable organization are willing to pay for desired products, specific product conditions the one or more charitable organization are willing to accept, and tax information for the one or more charitable organizations.

3. The computer-based method of claim 1, wherein the received distribution information comprises a given set of vendor rules and conditions that indicate a returnable product is eligible for distribution to a charitable organization.

4. The computer-based method of claim 3, wherein the received distribution information further comprises vendor-sold products that are eligible for distribution upon being returned, vendor rules including acceptable conditions for the returned products to be eligible for distribution, and specific prices for each of the returnable products when in a given condition.

5. The computer-based method of claim 1, wherein automatically generating the ranking for each of the identified one or more charitable organizations eligible to receive the product further comprises:
calculating a numeric score based on several factors comprising one or more of: shipping expense cost from a given return site, the price a given charitable organization is willing to pay for the returned product, whether the returned product is permitted to be donated for free, and need and priority of the given charitable organization to receive the returned product.

6. The computer-based method of claim 1, wherein the generated return shipping label corresponding to the highest ranked charity comprises a bar code.

7. The computer-based method of claim 1, wherein automatically determining whether the product included in the received return request is eligible for distribution based on the distribution information from the vendor further comprises:
receiving an image of the product from the customer and automatically utilizing image recognition software to determine the condition of the product.

8. A computer system, the computer system comprising:
one or more processors, one or more computer-readable memories, one or more computer-readable tangible storage medium, and program instructions stored on at least one of the one or more computer-readable tangible storage medium for execution by at least one of the one or more processors via at least one of the one or more computer-readable memories, wherein the computer system is capable of performing a method comprising:
automatically receiving a wish list from one or more charitable organizations;
automatically receiving distribution information from a vendor;
automatically receiving a return request for a product from a customer;
automatically determining whether the product included in the received return request is eligible for distribution based on the received distribution information from the vendor;
in response to determining that the product included in the received return request is eligible for distribution, automatically identifying one or more charitable organizations that are eligible to receive the product;
automatically generating a ranking for each of the identified one or more charitable organizations eligible to receive the product; and
based upon the generated rankings, automatically generating a return shipping label corresponding to a highest ranked charitable organization eligible to receive the product.

9. The computer system of claim 8, wherein automatically receiving the wish list from the one or more charitable organizations further comprises:
automatically receiving and storing specific price ranges the one or more charitable organization are willing to pay for desired products, specific product conditions the one or more charitable organization are willing to accept, and tax information for the one or more charitable organizations.

10. The computer system of claim 8, wherein the received distribution information comprises a given set of vendor rules and conditions that indicate a returnable product is eligible for distribution to a charitable organization.

11. The computer system of claim 10, wherein the received distribution information further comprises vendor-sold products that are eligible for distribution upon being returned, vendor rules including acceptable conditions for the returned products to be eligible for distribution, and specific prices for each of the returnable products when in a given condition.

12. The computer system of claim 8, wherein automatically generating the ranking for each of the identified one or more charitable organizations eligible to receive the product further comprises:
calculating a numeric score based on several factors comprising one or more of: shipping expense cost from a given return site, the price a given charitable organization is willing to pay for the returned product, whether the returned product is permitted to be donated for free, and need and priority of the given charitable organization to receive the returned product.

13. The computer system of claim 8, wherein the generated return shipping label corresponding to the highest ranked charity comprises a bar code.

14. The computer system of claim 8, wherein automatically determining whether the product included in the received return request is eligible for distribution based on the distribution information from the vendor further comprises:
receiving an image of the product from the customer and automatically utilizing image recognition software to determine the condition of the product.

15. A computer program product, the computer program product comprising:
one or more computer-readable tangible storage medium and program instructions stored on at least one of the one or more computer-readable tangible storage medium, the program instructions executable by a processor capable of performing a method, the method comprising:
automatically receiving a wish list from one or more charitable organizations;
automatically receiving distribution information from a vendor;
automatically receiving a return request for a product from a customer;
automatically determining whether the product included in the received return request is eligible for distribution based on the received distribution information from the vendor;
in response to determining that the product included in the received return request is eligible for distribution, automatically identifying one or more charitable organizations that are eligible to receive the product;
automatically generating a ranking for each of the identified one or more charitable organizations eligible to receive the product; and
based upon the generated rankings, automatically generating a return shipping label corresponding to a highest ranked charitable organization eligible to receive the product.

16. The computer program product of claim 15, wherein automatically receiving the wish list from the one or more charitable organizations further comprises:
automatically receiving and storing specific price ranges the one or more charitable organization are willing to pay for desired products, specific product conditions the one or more charitable organization are willing to accept, and tax information for the one or more charitable organizations.

17. The computer program product of claim 15, wherein the received distribution information comprises a given set of vendor rules and conditions that indicate a returnable product is eligible for distribution to a charitable organization.

18. The computer program product of claim 17, wherein the received distribution information further comprises vendor-sold products that are eligible for distribution upon being returned, vendor rules including acceptable conditions for the returned products to be eligible for distribution, and specific prices for each of the returnable products when in a given condition.

19. The computer program product of claim 15, wherein automatically generating the ranking for each of the identified one or more charitable organizations eligible to receive the product further comprises:
calculating a numeric score based on several factors comprising one or more of: shipping expense cost from a given return site, the price a given charitable organization is willing to pay for the returned product, whether the returned product is permitted to be donated for free, and need and priority of the given charitable organization to receive the returned product.

20. The computer program product of claim 15, wherein the generated return shipping label corresponding to the highest ranked charity comprises a bar code.
